(19) United States
(12) Patent Application Publication
(10) Pub. No.: US 2021/0089933 A1
(43) Pub. Date: Mar. 25, 2021

(54) METHOD AND APPARATUS FOR LEARNING PROCEDURAL KNOWLEDGE, AND METHOD FOR PROVIDING SERVICE USING THE SAME

(71) Applicant: ELECTRONICS AND TELECOMMUNICATIONS RESEARCH INSTITUTE, Daejeon (KR)

(72) Inventors: Hwajeon SONG, Daejeon (KR); Hyun Woo KIM, Daejeon (KR); Euisok CHUNG, Daejeon (KR); Ho Young JUNG, Daejeon (KR); Yunkeun LEE, Daejeon (KR)

(73) Assignee: ELECTRONICS AND TELECOMMUNICATIONS RESEARCH INSTITUTE, Daejeon (KR)

(21) Appl. No.: 16/902,513

(22) Filed: Jun. 16, 2020

(30) Foreign Application Priority Data
Sep. 20, 2019 (US) 10-2019-0116089

(51) Int. Cl. G06N 5/02; G09B 7/04; G06N 3/08; G06N 3/04

(52) U.S. Cl. CPC G06N 5/022; G09B 7/04; G06N 3/0454; G06N 3/0445; G06N 3/08

(57) ABSTRACT

An apparatus for learning procedural knowledge generates procedural knowledge data by connecting unit knowledge that is generated though each episode through interaction with a user, stores the procedural knowledge data generated from each episode in a short-term memory, estimates data to be long-term memorized from the procedural knowledge data stored in the short-term memory, converts the estimated data into long-term memory data, and stores the long-term memory data in a long-term memory.

### CROSS-REFERENCE TO RELATED APPLICATION

This application claims priority to and the benefit of Korean Patent Application No. 10-2019-0116089 filed in the Korean Intellectual Property Office on Sep. 20, 2019, the entire contents of which are incorporated herein by reference.

### BACKGROUND OF THE INVENTION

### (a) Field of the Invention

The present invention relates to a method and apparatus for learning procedural knowledge, and a method for providing service using the same. More specifically, the present invention relates to a method and apparatus for learning procedural knowledge, and a method for providing service using the same that are capable of compressively accumulating procedural knowledge and suggesting a solution through the accumulated procedural knowledge.

### (b) Description of the Related Art

People remember the procedure of achieving success or satisfactory results by repeating the same or similar works, and then do not repeat the mistakes of the past as much as possible based on the memory. In other words, experiences are accumulated and using it are repeated, and then if these repetitions are accumulated in the memory of a person, it is possible to perform actions or tasks more efficiently based on the accumulated memory from experience instead of starting anew from the beginning.

A differential neural computer (DNC) is a system in which a neural network, a memory, an interface, etc., are combined. The DNC consists of a neural network that can read and write an external memory matrix. The DNC can display and process complex data structures using memory like a general computer, and learn through data like a neural network. In this way, the DNC can write and read information like the general computer, and also records association with past information by memorizing link information of related information. However, when the same results are obtained, but the procedures are different, or the same procedures are performed, but the results are different, the DNC does not effective provides the solution.

### SUMMARY OF THE INVENTION

The present invention has been made in an effort to provide a method and apparatus for learning procedural knowledge, and a method for providing a service using the same having advantages of suggesting an effective solution to a request of user by accumulating and reusing procedural knowledge.

According to an exemplary embodiment of the present invention, a method for learning procedural knowledge by a procedural knowledge learning apparatus is provided. The method for learning procedural knowledge includes: generating procedural knowledge data by connecting unit knowledge that is generated though each episode through interaction with a user; storing the procedural knowledge data generated from each episode in a short-term memory; estimating data to be long-term memorized from the procedural knowledge data stored in the short-term memory; and converting the estimated data into long-term memory data and storing the long-term memory data in a long-term memory.

The estimating may include determining procedural knowledge data that is repeated a predetermined number of times as the data to be long-term memorized.

The determining may include determining procedural knowledge data having similarity of a predetermined threshold or more among the procedural knowledge data that is repeated a predetermined number of times as the data to be long-term memorized.

The storing of the long-term memory data may include storing the procedure knowledge data having the same procedure and different results in a predetermined region of the long-term memory.

The storing of the long-term memory data may include storing procedure knowledge data having different procedures and the same result in a predetermined region of the long-term memory.

The method for learning procedural knowledge may further include: outputting a key value for finding the solution to a current input based on the current input and a key value immediately output from the short-term memory; and outputting a key value for finding the solution to a current input based on the current input and a key value immediately output from the long-term memory.

According to another embodiment of the present invention, an apparatus for learning procedural knowledge is provided. The apparatus for learning procedural knowledge includes a short-term memory network, a long-term memory network, and a controller. The short-term memory network stores procedural knowledge data as short-term memory data in short-term memory, and outputs a key value for finding a solution to a current input from the short-term memory based on the current input and a key value immediately output from the short-term memory. The long-term memory network stores long-term memory data in long-term memory, and outputs a key value for finding a solution to the current input from the long-term memory based on the current input and a key value immediately output from the long-term memory. The controller that generates the procedural knowledge data by connecting unit knowledge that is generated from each episode through interaction with a user, transfers the procedural knowledge data to the short-term memory network, estimates data to be converted into the long-term memory data among the procedural knowledge data, and transfers the estimated data to the long-term memory network as the long-term memory data.

The controller may estimate procedural knowledge data that is repeated a predetermined number of times or more with similarity of a predetermined threshold or more as the long-term memory data.

The controller may store procedure knowledge data having the same procedure and different results in a predetermined region of the long-term memory.

The control unit may store procedure knowledge data having different procedures and the same result in a predetermined region of the long-term memory.

According to another embodiment of the present invention, a method for providing service in which a service providing apparatus suggests a solution to a request of user is provided. The method for providing service includes: receiving a request from the user; providing a solution to the request based on data recorded to the short-term memory network and the long-term memory network; storing procedural knowledge data corresponding to the process from the request to the solution as a result generated from one episode in the short-term memory network; and storing at least a part of the procedural knowledge data stored in the short-term memory to the long-term memory network by long-term memorizing.

The storing of at least a part of the procedural knowledge data may include converting procedural knowledge data that is repeated a predetermined number of times or more with similarity of a predetermined threshold or more among data stored in the short-term memory network into data to be long-term memorized.

The storing of at least a part of the procedural knowledge data may further include storing procedure knowledge data having the same procedure and different results in a predetermined region of the long-term memory.

The storing of at least a part of the procedural knowledge data may further include storing procedure knowledge data having different procedures and the same result in a predetermined region of the long-term memory.

The providing the solution may include: receiving a key value for finding a solution to a current input from the long-term memory network based on the current input and a key value output immediately before from the long-term memory network; receiving a key value for finding the solution to a current input from the short-term memory network based on the current input and a key value immediately output from the short-term memory network; and generating the solution based on the key values received from the short-term memory network and the long-term memory network.

The request includes a coordination request of fashion style.

### BRIEF DESCRIPTION OF THE DRAWINGS

FIG. 1 is a diagram illustrating a method for learning procedural knowledge according to an embodiment of the present invention.

FIG. 2 is a diagram schematically illustrating a system for providing service according to an embodiment of the present invention.

FIG. 3 is a flowchart illustrating a method for providing service according to an embodiment of the present invention.

FIG. 4 is a diagram illustrating an example of the episode referred in FIG. 1.

FIG. 5 is a diagram schematically illustrating a system for providing service according to an exemplary embodiment of the present invention.

### DETAILED DESCRIPTION OF THE EMBODIMENTS

Hereinafter, embodiments of the present invention will be described in detail with reference to the attached drawings so that a person of ordinary skill in the art may easily implement the present invention. The present invention may be modified in various ways, and is not limited thereto. In the drawings, elements that are irrelevant to the description of the present invention are omitted for clarity of explanation, and like reference numerals designate like elements throughout the specification.

Throughout the specification and claims, when a part is referred to “include” a certain element, it means that it may further include other elements rather than exclude other elements, unless specifically indicated otherwise.

Hereinafter, a method and apparatus for learning procedural knowledge, and a method for providing service using the same according to embodiments of the present invention will be described in detail with reference to the accompanying drawings.

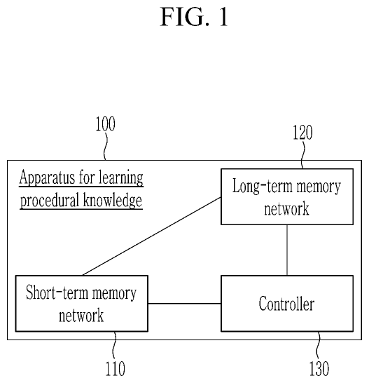

FIG. 1 is a diagram illustrating a method for learning procedural knowledge according to an embodiment of the present invention.

Referring to FIG. 1, procedural knowledge is expressed as a collection of sequential or structural actions or a collection of unit procedural knowledge to achieve a specific purpose. That is, each unit procedure knowledge forms a relationship with others to form a solution for achieving the purpose.

The apparatus for learning procedural knowledge learns about procedural knowledge, stores and manages repeated procedural knowledge as long-term memory, and outputs the result through memory for procedural knowledge when a request is received from a user.

The apparatus for learning procedural knowledge 100 includes a short-term memory network 110, a long-term memory network 120, and a control unit 130.

The short-term memory network 110 stores unit knowledge data from episodes as short-term memory data in a short-term memory through a write operation when an episode with a user corresponding to the unit knowledge is given as input data. The short-term memory network 110 stores procedural knowledge data generated from the episode through interaction with the user as short-term memory data in short-term memory. In addition, the short-term memory network 110 outputs a key value for finding a desired solution to current input data from the short-term memory through a read operation based on the current input data and a key value output immediately before from the short-term memory. The key value may refer to a part of procedural knowledge data stored in the short-term memory. The data stored in the short-term memory may be updated or deleted by new data.

The long-term memory network 120 stores data to be memorized in a long-term state, that is, long-term memory data in a long-term memory through a write operation. The long-term memory data may refer to data in which existing memories are not deleted even when new memories are learned. The long-term memory network 120 outputs a key value for finding a desired solution to the current input data through a read operation based on the current input data and a key value output immediately before from the long-term memory.

The controller 130 generates procedural knowledge data from one episode by connecting the unit procedural knowledge that performed the episode through interaction with the user from the episode, and stores the procedural knowledge data in short-term memory. In addition, the controller 130 estimates data to be converted into long-term memory data among procedural knowledge data, and stores the estimated data in long-term memory as long-term memory data. In order to convert procedural knowledge data stored in short-term memory into long-term memory data, iterations of data over a predetermined number of times are required. The controller 130 may determine to convert procedural knowledge data that is repeated the predetermined number of times or more with similarity of a predetermined threshold or more as the long-term memory data.

The controller 130 accesses the short-term memory network 110 and the long-term memory network 120 using read operations and write operations, and suggests a solution to the request of the user.

As described above, procedural knowledge data is generated from episodes corresponding to short-term memory data and stored in the short-term memory network 110, and when a large number of episodes occur, procedural knowledge data corresponding to the episodes are stored in short-term memory network 110 in turn.

At this time, if many similar episodes are repeated, corresponding procedural knowledge data become long-term memorized, and then are stored in a similar location in the long-term memory network 120. Furthermore, if episodes having similar procedures and different results occur several times, the procedural knowledge data corresponding to the episodes become long-term memorized, and are then stored in a similar location in the long-term memory network 120. In order to make up such memories, the controller 130 may group episodes having similar results and store procedural knowledge data generated from the episodes in a similar location, for example, a same region in the long-term memory network 120. In addition, the controller 130 may group episodes having similar procedures and different results and store procedural knowledge data generated from the episodes in a similar location, for example, in a same region in the long-term memory network 120.

That is, although it is a similar episode, the results may vary depending on the preference of the user and TPO (Time/Place/Occasion), so all the procedural knowledge data generated from these episodes are stored in the short-term memory network 110, and thereafter data to be long-term memorized is stored in the long-term memory network 120.

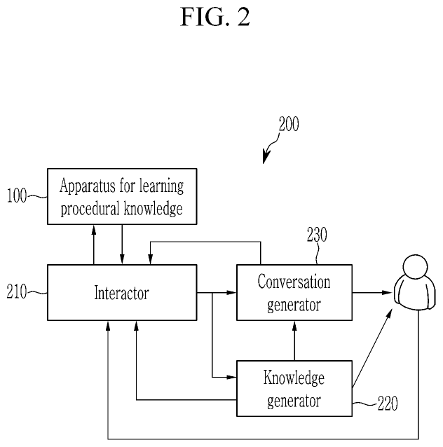

FIG. 2 is a diagram schematically illustrating a system for providing service according to an embodiment of the present invention.

Referring to FIG. 2, the system for providing service 200 includes an interactor 210, a knowledge generator 220, and a conversation generator 230. In addition, the system for providing service 200 may further include the apparatus for learning procedural knowledge 100 shown in FIG. 1.

The interactor 210 interacts with the short-term memory network 110 and the long-term memory network 120 of the apparatus for learning procedural knowledge 100. Furthermore, the interactor 210 interacts with the user. The interactor 210 transfers input data to the short-term memory network 110 and the long-term memory network 120, receives key values for input data output from the short-term memory network 110 and the long-term memory network 120, and transfers the key values to the generator 230 and the knowledge generator 220. The input data may include conversations generated by the conversation generator 230. The input data may include key values immediately before output from the short-term memory network 110 and the long-term memory network 120. In addition, the input data may include data input from the user. The interactor 210 may receive responses of the user to the solution suggested by the knowledge generator 220 and compensate for key values associated with the suggested solution.

The knowledge generator 220 generates the solution to be suggested to the user based on the key values provided by the interactor 210, and outputs the solution to the user.

The conversation generator 230 generates conversations to be transferred to the user based on the key values provided by the interactor 210 and the solution suggested by the knowledge generator 220, and outputs the conversations.

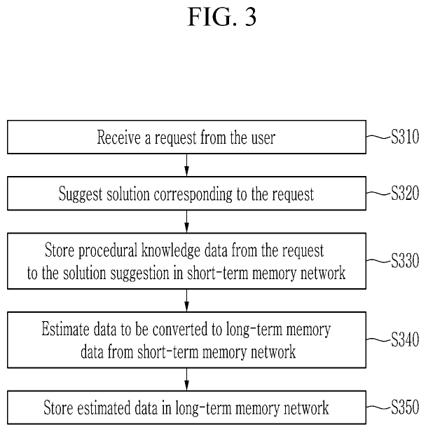

FIG. 3 is a flowchart illustrating a method for providing service according to an embodiment of the present invention.

Referring to FIG. 3, when the system for providing service 200 receives a request from the user (S310), it suggests the solution corresponding to the request of the user (S320). The system for providing service 200 suggests the solution to the request of the user based on data recorded in the short-term memory network 110 and the long-term memory network 120.

The system for providing service 200 stores procedural knowledge data corresponding to a process from the request to the solution suggestion as a result generated from one episode in the short-term memory network 110 (S330).

In this way, the system for providing service 200 may store unit knowledge and procedural knowledge data corresponding to many episodes in a short-term memory network 110.

The system for providing service 200 estimates data to be converted to long-term memory data from the short-term memory network (S340), outputs the estimated data from the short-term memory network 110, and stores it in the long-term memory network 120 (S350). Since the data stored in the long-term memory network 120 are not affected by the new data, the solution to the request of the user may be suggested more efficiently from the data.

As described above, according to an embodiment of the present invention, the procedural knowledge (experience) is compressively accumulated into the long-term memory like for people, and accordingly, a solution to the request of the user can be suggested as efficiently as possible based on the stored procedural knowledge.

The following describes an example of an artificial intelligence (AI) fashion coordinator acquiring memory of procedural knowledge and using it through conversations between an AI fashion coordinator and a customer for effective explanation of the embodiments of the present invention. The AI fashion coordinator may refer to the system for providing service 200 including the apparatus for learning procedural knowledge 100.

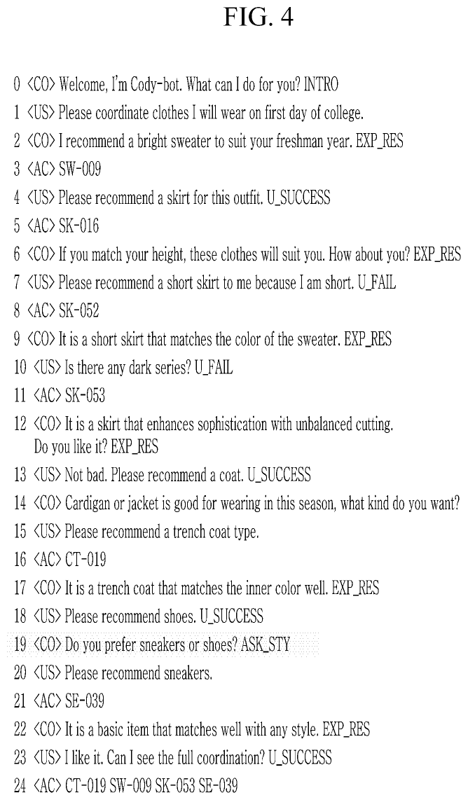

FIG. 4 is a diagram illustrating an example of the episode referred to in FIG. 1, and is an example of an episode of completing coordination through conversations between a customer and an AI fashion coordinator. In FIG. 4, <AC> represents a single item or a set of costumes suggested by the AI fashion coordinator, and <CO> represents a conversation generated by the AI fashion coordinator after the AI fashion coordinator outputs the <AC>. <US>represents the conversation generated by the customer after checking the <AC> and <CO> generated by the AI fashion coordinator. Here, the customer may represent a user.

Referring to FIG. 4, it is assumed that conversations have started for fashion coordination desired by the customer. The AI Fashion Coordinator outputs an intro greeting “Welcome. I'm Cody-bot. What can I do for you?”

The customer requests the desired coordination. For example, a customer may ask “Please coordinate the clothes I will wear the first day of college.”

The AI fashion coordinator generates input data for coordinating desired by the customer, transfers the input data to the short-term memory network 110 and the long-term memory network 120, and suggests the solution “SW-009” based on key values output from the short-term memory network 110 and the long-term memory network 120 to the customer. In this case, the input data may be, for example, a freshman of the college or a jacket.

Here, the code value suggested as the solution may represent an image of the clothes. The letter among code values may be used to classify clothes categories such as coats, sweaters, skirts, and shoes, and the number among code values may represent unique items registered for each category of clothes. For example, “SW-009” may represent the ninth registered sweater. Each unique item may include not only the image, but also all related clothing information such as color, shape, and material.

The AI fashion coordinator can recommend the most suitable coordinating clothes by comparing all information related to the clothes provided with each clothes item in order to suggest the most appropriate coordination. In addition, as described above, the AI fashion coordinator may recommend clothes using data stored in the short-term memory network 110 and the long-term memory network 120. The AI fashion coordinator can continuously reflect the knowledge of recent trends in order to suggest the coordination that the customer is most satisfied with.

The customer can request a change if the customer is not satisfied with all or part of the suggested coordination. It is assumed that the request is made through a variety of conversations. These conversations are input to the AI fashion coordinator.

That is, the customer responds to this solution “SW-009”. The response may include requesting the next coordination or requesting another coordination. The AI fashion coordinator can determine whether the solution suggested is a success or failure based on the response input from the customer.

If the customer determines that the solution “SW-009” suggested by the AI fashion coordinator is satisfactory, the customer can request the next coordination. For example, the customer may request “Please recommend a skirt for this outfit.”

The AI fashion coordinator generates input data for the coordination desired by the customer, transfers the input data and key value corresponding to “SW-009” to the short-term memory network 110 and the long-term memory network 120, and suggests a solution “SK-016” based on the key values output from the 110 and the long-term memory network 120 to the customer. At this time, the input data may be, for example, a skirt.

The customer responds to the solution “SK-016”. For example, if the customer is not satisfied with the solution “SK-016, the customer may request “Please recommend a short skirt to me because I am short.”

The AI fashion coordinator generates input data corresponding to the request of the customer “Please recommend a short skirt to me because I am short”, transfers the input data and key value corresponding to “SW-009” to the short-term memory network 110 and the long-term memory network 120, and suggests a solution “SK-052” based on the key values output from the 110 and the long-term memory network 120 to the customer. At this time, the input data may be, for example, the short skirt.

In this way, the AI fashion coordinator can suggest the final solutions “CT-019, SW-009, SK-053, SE-039” through conversations with the customer.

The customer notifies the AI fashion coordinator whether or not to select the final solutions “CT-019, SW-009, SK-053, SE-039”, and the AI fashion coordinator receives information about selection of the final solutions “CT-019, SW-009, SK-053, SE-039”, and ends the conversations with the customer. This is the episode unit.

The AI fashion coordinator may perform learning in the way that compensates for the suggested coordination if it is selected, and give a penalty if it is not selected. At this time, the AI fashion coordinator may suggest one or more solutions, compensate for one or more solutions, and estimate compensation from the response or conversation of the customer.

When these episodes are given, the AI fashion coordinator generates these sequences as procedural knowledge data and stores the procedural knowledge data in the short-term memory network 110. In addition, the AI fashion coordinator stores and manages at least some of procedural knowledge data generated from a large number of episodes as long-term memory data that is long-term memorized according to predetermined criteria in the long-term memory network 120.

If the process of similar coordination is repeated many times, the AI fashion coordinator makes the procedural knowledge data of the corresponding coordination into long-term memory data, and stores the long-term memory data in a similar location in the long-term memory network 120. Furthermore, when coordination having same procedures and different results occurs many times, it also makes long-term memory data and stores it in a similar location in the long-term memory network 120.

As such, the AI fashion coordinator can interact with the short-term memory network 110 and the long-term memory network 120, so it may appropriately respond to situations that follow the same procedures but can output various results, and may appropriately respond with opposite situations that follow the different procedures but can output the same results corresponding to the opposite situations.

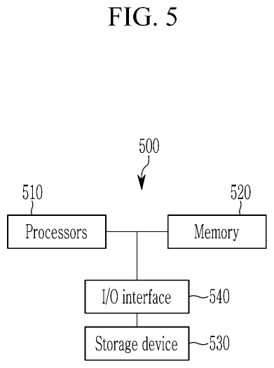

FIG. 5 is a diagram schematically illustrating a system for providing service according to an exemplary embodiment of the present invention.

Referring to FIG. 5, the system for providing service 500 includes a plurality of processors 510, a memory 520, a storage device 530, and an input/output (I/O) interface 540.

Each processor 510 may be implemented as a central processing unit (CPU) or other chipset, a microprocessor, etc.

The memory 520 may be implemented as a medium such as random access memory (RAM), dynamic random access memory (DRAM), rambus DRAM (RDRAM), synchronous DRAM (SDRAM), static RAM (SRAM), etc.

The storage device 530 may be implemented as a hard disk, optical disks such as a compact disk read only memory (CD-ROM), a CD rewritable (CD-RW), a digital video disk ROM (DVD-ROM), a DVD-RAM, a DVD-RW disk, Blu-ray disks, etc., a flash memory, or permanent or volatile storage devices such as various types of RAM.

The memory 520 or the storage device 530 may include short-term memory and long-term memory described above.

The I/O interface 540 allows the processor 510 and/or memory 520 to access the storage device 530. In addition, the I/O interface 540 may provide an interface with the user.

At least one of the plurality of processors 510 stores and manages long-term memory data to be long-term memorized by performing a function for learning procedural knowledge described in FIGS. 1 to 4. At least another one of the plurality of processors 510 may perform a function for suggesting a solution to the request of the user by accessing to the short-term memory network 110 and the long-term memory network 120. The plurality of processors 510 may load a program command for implementing the function for learning procedural knowledge or the function for suggesting a solution to the request of the user in the memory 520, and may control to perform the operation described with reference to FIGS. 1 to 4. These program commands may be stored in the storage device 530, or may be stored in another system connected through a network.

In addition, a system that implements the function for learning procedural knowledge or the function for suggesting a solution to the request of the user may be independent.

According to an embodiment of the present invention, the procedural knowledge (experience) is compressively accumulated into memory like people do, and accordingly, it can suggest a solution to the request of the user as efficiently as possible based on the stored procedural knowledge. Furthermore, since it is possible to change the structure and method of the system in this way, most of the systems in operation can be replaced.

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (08) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

What is claimed is:

1. A method for learning procedural knowledge by a procedural knowledge learning apparatus, the method comprising:
generating procedural knowledge data by connecting unit knowledge that is generated from each episode through interaction with a user;
storing the procedural knowledge data generated from each episode in a short-term memory;
estimating data to be long-term memorized from the procedural knowledge data stored in the short-term memory; and
converting the estimated data into long-term memory data and storing the long-term memory data in a long-term memory.

2. The method of claim 1, wherein the estimating includes determining procedural knowledge data that is repeated a predetermined number of times or more as the data to be long-term memorized.

3. The method of claim 2, wherein the determining includes determining procedural knowledge data having similarity of a predetermined threshold or more among the procedural knowledge data that is repeated a predetermined number of times as the data to be long-term memorized.

4. The method of claim 3, wherein the storing of the long-term memory data includes storing the procedure knowledge data having the same procedure and different results in a predetermined region of the long-term memory.

5. The method of claim 3, wherein the storing of the long-term memory data includes storing procedure knowledge data having different procedures and the same result in a predetermined region of the long-term memory.

6. The method of claim 1, further comprising:
outputting a key value for finding the solution to a current input based on the current input and a key value immediately output from the short-term memory; and
outputting a key value for finding the solution to a current input based on the current input and a key value immediately output from the long-term memory.

7. An apparatus for learning procedural knowledge, the apparatus comprising:
a short-term memory network that stores procedural knowledge data as short-term memory data in short-term memory, and outputs a key value for finding a solution to a current input from the short-term memory based on the current input and a key value immediately output from the short-term memory;
a long-term memory network that stores long-term memory data in long-term memory, and outputs a key value for finding a solution to the current input from the long-term memory based on the current input and a key value immediately output from the long-term memory; and
a controller that generates the procedural knowledge data by connecting unit knowledge that is generated each episode through interaction with a user, transfers the procedural knowledge data to the short-term memory network, estimates data to be converted into the long-term memory data among the procedural knowledge data, and transfers the estimated data to the long-term memory network as the long-term memory data.

8. The apparatus of claim 7, wherein the controller estimates procedural knowledge data that is repeated a predetermined number of times or more with similarity of a predetermined threshold or more as the long-term memory data.

9. The apparatus of claim 8, wherein the controller stores procedure knowledge data having the same procedure and different results in a predetermined region of the long-term memory.

10. The apparatus of claim 8, wherein the control unit stores procedure knowledge data having different procedures and the same result in a predetermined region of the long-term memory.

11. A method for providing service in which a service providing apparatus suggests a solution to a request of user, the method comprising:
receiving a request from the user;
providing a solution to the request based on data recorded to the short-term memory network and the long-term memory network;
storing procedural knowledge data corresponding to the process from the request to the solution as a result generated from one episode in the short-term memory network; and
storing at least a part of the procedural knowledge data stored in the short-term memory to the long-term memory network by long-term memorizing.

12. The method of claim 11, wherein the storing of at least a part of the procedural knowledge data includes converting procedural knowledge data that is repeated a predetermined number of times or more with similarity of a predetermined threshold or more among data stored in the short-term memory network into data to be long-term memorized.

13. The method of claim 12, wherein the storing of at least a part of the procedural knowledge data further includes storing procedure knowledge data having the same procedures and different results in a predetermined region of the long-term memory.

14. The method of claim 12, wherein the storing of at least a part of the procedural knowledge data further includes storing procedure knowledge data having different procedures and the same result in a predetermined region of the long-term memory.

15. The method of claim 11, wherein the providing the solution includes:
receiving a key value for finding a solution to a current input from the long-term memory network based on the current input and a key value output immediately before from the long-term memory network;
receiving a key value for finding the solution to a current input from the short-term memory network based on the current input and a key value immediately output from the short-term memory network; and
generating the solution based on the key values received from the short-term memory network and the long-term memory network.

16. The method of claim 11, wherein the request includes a request for coordination of fashion style.
